(19) United States
(12) Patent Application Publication
(10) Pub. No.: US 2003/0059546 A1
(43) Pub. Date: Mar. 27, 2003

(54) Coated paper

(76) Inventor: Dean Johnson, Columbia, MD (US)

Correspondence Address: Donald L. Bowman, Westvaco Corporation, 11101 Johns Hopkins Road, Laurel, MD, 20723, US

(21) Appl. No.: 10/265,854

(22) Filed: Oct. 7, 2002

Related U.S. Application Data
(63) Continuation-in-part of application No. 09/709,501, filed on Nov. 13, 2000.

(51) Int. Cl. B05D 1/36

(52) U.S. Cl. 427/402

(57) ABSTRACT

A method of making a paper suitable for photographic printing applications.

### CROSS RELATED APPLICATIONS

This application is continuation in part of U.S. patent application Ser. No. 09/709,501 filed on Nov. 13, 2000.

### FIELD OF THE INVENTION

The invention is directed to a method of manufacturing a paper for use in photographic printing applications. Description of Prior Art

Photographic printing is typically done on paper that is coated with a photosensitive emulsion layer. Prior to placing photosensitive emulsion layer on the paper, the paper is coated and mechanically treated to provide a smooth surface. FIG. 1 illustrates a conventional paper 100. The base stock 101 is shown coated on both sides with a conventional sizing coating 116, such as a starch coating with pigments. The paper 100 then undergoes a conventional mechanical calendaring step to improve smoothness. After calendaring, the paper 100 is typically coated with a polymer coating (not shown), such as an extruded polyolefin coating. Then a conventional photosensitive emulsion coating (not shown) is placed over the polymer coating (not shown).

Issued European Patent EP 0 952 483 B ('483 patent) filed on Mar. 20, 1999 and granted on Jul. 24, 2002 discloses a conventional paper for photographic printing applications. FIG. 2 illustrates the conventional paper 200 as taught in the '483 patent. The base stock 201 is illustrated coated on both sides with a size coating 212, such as a conventional starch coating mixture. A conventional mineral pigmented coating 218 is illustrated secured to one of the size coating layers 212. The conventional paper 200 is then finished as described above for paper 100.

FIG. 3 is a schematic illustration of a conventional manufacturing apparatus 300 for forming the conventional paper 200 of FIG. 2. The base stock 201 is exemplary illustrated traveling from headbox 305 to the paper reel 370. The base stock 201 typically goes through a wet press 310. The base stock 201 is then dried in a conventional dryer system 320. The base stock 201 then is mechanically pressed through a calender apparatus 330. The calendering limits absorption of the sizing coating 212 into the base stock 201. The size coating 212 is then applied to the base stock 201 by a coating apparatus 340, such as a sizing press. After the sizing coating 212 is applied, the base stock 201 is dried in a conventional dryer system 350. After drying, the base stock 201 is further mechanically pressed through a second calender apparatus 360. The sized paper is then typically wound up in a reel 370.

FIG. 4 illustrates a schematic illustration of a conventional manufacturing apparatus 400 for securing additional coatings to the sizing layer 212 of FIG. 2. Apparatus 400 is exemplary located after reel 370 has been formed although it could alternatively be one continuous process located prior to reel 370 in FIG. 3. The sized paper is rolled out and an additional mineral coating 218 is placed on the size coating 212 by a conventional coating apparatus 410. After the paper 200 is coated it undergoes an additional mechanical calendaring by a calendaring apparatus 420. The paper web 200 is then rolled into reel 430. Additional coatings such as a polymer coating (not shown) and a photo sensitive coating (not shown) can be applied to reel 430 using conventional techniques.

The smoothness of paper 200 for photographic applications is important to the appearance of photographic prints. A range of factors can impact the smoothness of the finished paper 200, but the critical factor is the smoothness of the base stock 201 and the coatings 212, 218. For example, a lack of uniformity in the distribution of fiber, fiber flocs and other materials in base stock 201 formation contribute to the roughness of the base stock 201. For example, uneven fiber distribution can lead to the formation of craters in the surface of the base stock 201. These defects if not addressed are then carried forward from the base stock 201 to the coating layers 212, 218. In addition, for photographic applications, stiffness and caliper are important physical characteristics. Typically, compaction of the fibers during finishing or smoothing processes, such as calendering apparatuses 330 and 420, may result in over-densification of the paper 200, which, in turn, leads to glassine areas that cause variations in the opacity of the paper 200.

The prior art method as illustrated in FIG. 3 produces a paper 200 with a stiffness range of about 205 millinewtons/15 micrometers to about 315 millinewton/15 micrometers in the cross direction and a range of about 505 millinetwons/micrometers to about 605 millinewtons/microimeters in the machine direction. In addition, the conventional method produces a paper with a caliper range of about 155 micrometers to about 170 micrometers. What is needed is a method of making a paper suitable for photographic printing applications with a smoothness of less than Ra=1 micrometer that does not require the calendaring steps of the prior art methods.

### SUMMARY OF THE INVENTION

In general, the invention is directed to a method of manufacturing a paper that is suitable for photographic printing applications. In an exemplary method, the base stock is coated with a mixture of hollow sphere plastic pigment, a whitening pigment and a binder. The coated paper is finished without at least one of the calendaring steps of the prior art. The resulting paper has a surface smoothness R_{A} of less than 1.0 micrometer.

### BRIEF DESCRIPTION OF THE FIGURES

FIG. 1 schematically illustrates a conventional paper;

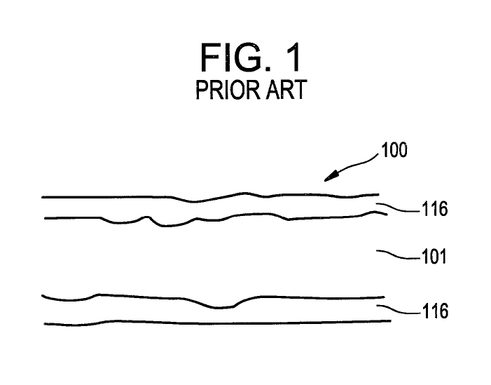

FIG. 2 schematically illustrates a conventional paper;

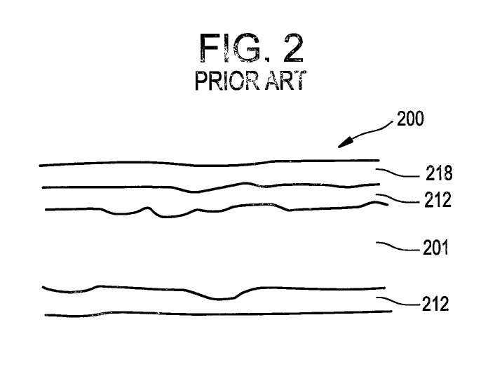

FIG. 3 schematically illustrates a conventional apparatus for forming the paper of FIG. 2;

FIG. 4 schematically illustrates a further conventional apparatus for forming the paper of FIG. 2;

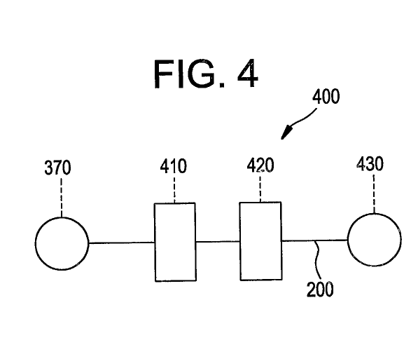

FIG. 5 schematically illustrates a paper according to the invention;

FIG. 6 schematically illustrates an apparatus for forming the paper of FIG. 5, according to the invention; and

FIG. 7 further schematically illustrates an exemplary apparatus for forming the paper of FIG. 5.

### DETAILED DESCRIPTION OF THE INVENTION

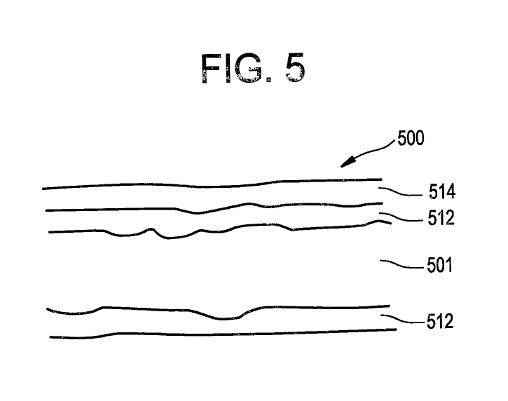

FIG. 5 schematically illustrates a paper 500 according to the invention. The base stock 501 is exemplary formed from natural fibers such as wood pulp. The thickness of the base stock 501 may be varied depending on the desired caliper and stiffness of the finished paper. An exemplary base stock 501 has a caliper in the range of about 155 micrometer to about 173 micrometers with an exemplary basis weight of from about 100 pounds per 3,300 square feet (lbs./ream) to about 140 pounds per 3,300 square feet (lbs./ream). A second exemplary basis weight range is about 110 pounds per 3,300 square feet (lbs./ream) to about 118 pounds per 3,300 square feet (lbs./ream).

In an exemplary embodiment, a size coating 512 is applied to both sides of the base stock 501. The size coating 512 is exemplary an aqueous mixture that may include starch, polyvinyl alcohol (PVA) or other surface strengthening agents as the active sizing ingredient. In addition, the size coating 512 may further combine one or more other additives such as fluorescent whitening agents or chloride salts. In an exemplary embodiment, the size coating does not have pigments.

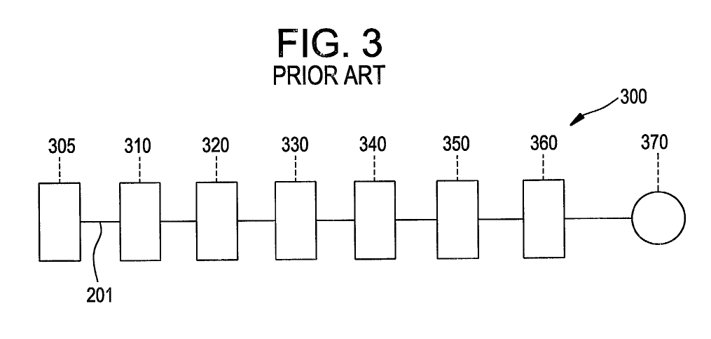

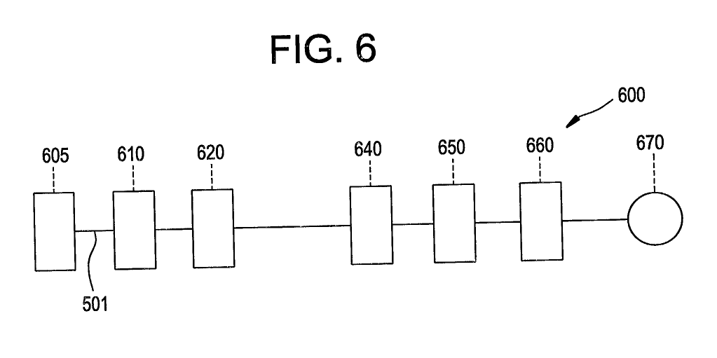

FIG. 6 schematically illustrates an exemplary method of forming the paper of FIG. 5. The base stock 501 is exemplary illustrated traveling from headbox 605 to the paper reel 670. The base stock 501 typically goes through a wet press 610. The base stock 501 is then dried in a conventional dryer system 620. The size coating 512 is then secured to the base stock 501 by a coating apparatus 640, such as a sizing press. While it is conventionally necessary according to the '483 patent for the base stock 501 to be calendered (330 of FIG. 3) before the entering the size coating 640, the invention eliminates the calendering step. After the sizing coating 512 is applied 640, the base stock 501 is dried in a conventional dryer system 650. After drying, the base stock 501 is mechanically pressed through a calender apparatus 660. The calendering may be accomplished using any calendering means 660 known in the art, such as gloss calenders, machine calenders, hot roll calenders and the like. The sized paper is exemplary illustrated wound up in a conventional reel 670.

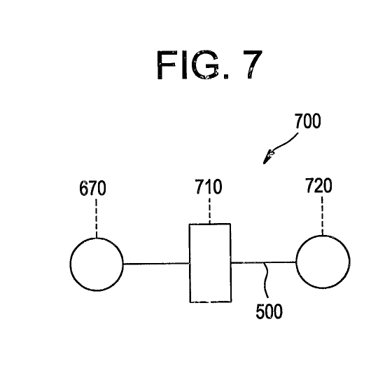

FIG. 7 schematically illustrates an exemplary apparatus 700 for securing coating 514 to the sizing coating 512. It is to be understood that apparatus 700 could be configured in many ways to include being added to the apparatus 600 of FIG. 6 prior to the reel 670. Reel 670 is unwound and coating 514 is secured to the sizing layer 512 by a coating apparatus 710. The paper web 500 is then exemplary rolled into reel 720. Coating 514 exemplary includes a high-bulk plastic pigment. The high-bulk plastic pigment may be a solid particulate pigment, or a hollow particulate pigment. Chemically, these pigments may be manufactured as hollow (singly voided) or multiply voided particles having void volumes of up to about 64%, preferably from about 22% to about 64%. Examples of these include styrene-acrylic copolymers and other polymers. The voids contribute to the bulk of the polymer particles and coating layers containing such polymers. Exemplary polymers that are commercially available include HS 2000, from Dow Chemical Inc., and ROPAQUE® HP-1055, from Rohm and Haas Inc. Other suitable examples of hollow plastic pigments for practicing the invention include those described in U.S. Pat. Nos. 5,639,805, 6,043,319 and 6,139,961, the entire disclosures of which are herein incorporated by reference. Preferably, the particle size of the hollow sphere plastic pigments is on the order of about 0.4 micrometers to about 1.0 micrometers. Solid particulate pigments, if used, typically are of a particle size less than 1.0 micrometers. The proportion of plastic pigment in the coating 514 may range from about 5% by weight to about 100% by weight, with an exemplary range from about 5% to about 25% by weight of plastic pigment based on the total pigment weight.

The plastic pigment advantageously replaces the fiber bulk that would traditionally be lost by the incorporation of only an inorganic pigment in the coating 514. Thus the plastic pigment maintains the basis weight of the resulting paper 500 at a desirable level. As a result, a higher paper caliper is made even though the overall fiber content is less than in conventional papers. This particularly desirable result is possible because the density of the plastic pigment is typically less than that of the fiber being replaced, while inorganic pigments have undesirable densities well in excess of typical fiber densities.

With a mineral pigment alone, the amount of fiber that would necessarily be replaced by such a pigment would limit the degree of densification that could be achieved while meeting paper caliper requirements. The resulting substrate would therefore have a surface that is less smooth. For example, if a proportion of the fiber in a base stock having a density of about 0.054 pounds per cubic inch (lb./in.³) is replaced with a mineral pigment such as calcium carbonate, having a density of about 0.090 lb./in.³, alone or in combination with titanium oxides having a density of about 0.144 lb/in³, a significant decrease in paper bulk and paper caliper is obtained. In contrast, a hollow sphere plastic pigment having a density of about 0.020 lb./in.³ may be used in a base stock coating to replace some of the fiber. Because the plastic pigment is of lower density, fiber replacement does not lead to a loss in paper bulk or an associated loss in paper caliper.

The plastic pigments may also be used in combination with conventional inorganic mineral pigments. Mineral pigments may be added to the coating where properties such as brightness and whiteness are desired. Thus clay is not a desirable mineral pigment. Mineral pigment addition levels can range from about 0% to about 95% weight based on total pigment weight. Because of the cost differential between the more expensive plastic pigments and mineral pigments, it is preferable to incorporate plastic pigment at a cost effective percentage. The total pigment amount in the coating may be up to about 85 parts per 100 parts of the total coating mixture, preferably from about 60 parts up to about 80 parts per 100 parts of the total coating mixture. Solid particulate plastic pigments may also be used according to the invention to provide increased paper caliper in comparison to mineral pigment coatings since solid plastic pigments have a lower density than mineral pigments.

As mentioned previously, the coating formulation may include one or more mineral pigments conventional to papermaking applications. Such pigments may be selected from whitening or brightening pigments or fillers. Examples of these include titanium oxides, calcium carbonate, barium sulfate and metal silicates. The binder used in the coating may be chosen from natural or synthetic coating binders such as starch, or polymers such as styrene-butadiene and others. The amount of binder added should be sufficient to adhere the coating to the substrate, bind any mineral pigments present in the coating to prevent them from being leached into the developer solution, and prevent discoloration of the coating by the developer while the photographic paper is being processed. As an example, if calcium carbonate is added as a mineral pigment, the amount of binder in relation to calcium carbonate, as well as the carbonate particle size should be adjusted to avoid undesirable leaching during the photographic developing process. In this regard, a binder level greater than 17 parts per 100 parts of coating formulation would be effective to prevent leaching when a mineral pigment such as calcium carbonate is used at a concentration of about 75 parts per 100 parts of coating formulation. Generally, the amount of binder in the coating formulation is in excess of about 15 parts per 100 parts of the total weight of coating formulation. Other additives such as optical brighteners, whitening agents, dyes, viscosity modifiers, dispersants, and chloride salts may also be included in the coating formulation.

The paper 500 formed according to the method of the invention has been found to have smoothness values that are significantly smoother than the smoothness values obtained with conventional methods. For example, a roughness value R_{A}, as measured by a laser based instrument method may be obtained in the range of less than about 0.8 microns. The exemplary methods of the invention yields roughness measures of from about 0.45 microns to about 0.73 microns. Another benefit of the invention is that while roughness is reduced in the finished product, paper caliper is retained. The products of the invention therefore may be characterized by caliper thickness ranging from about 150 micrometers to about 180 micrometers when the coating is applied at a coat weight of from about 2.5 pounds per 3,300 square feet to about 10 pounds per 3,300 square feet. Caliper range of about 163 micrometers to about 173 micrometers may be achieved when the coating is applied at a coat weight of from about 2.7 lb./ream to about 6.5 lb./ream.

Exemplary Size Coating Compositions

A first exemplary coating mixture (Coating 1) was prepared as follows:

25% by total coating mixture pigment weight hollow sphere plastic pigment (HSPP), approx. 0.8 micron m particle diameter, 50% sphere void volume, (such as product HS2000 from Dow Chemicals Inc.)

75% by total coating pigment weight CaCO₃, 0.7 micron nominal particle diameter, (such as product as HYDROCARB-90 (H-90) from Omya, Inc.)

18% weight. based on total pigment weight (such as product “DOW 638” binder Dow Chemicals Inc.)

A second exemplary coating mixture (Coating 2) was prepared as follows:

100% by total coating pigment weight CaCO₃, about 0.3 micron nominal particle diameter, (such as product as HYDROCARB-90 (H-90) from Omya, Inc.)

Coatings 1 and 2 were each applied to a base stock that had been machine calendered but not size coated. After applying coatings 1 and 2, the web was dried without calendering. A surface profiler instrument having a stylus set to varying degrees of sensitivity was used to evaluate the coating samples 1 and 2. The results indicated that coating 2 (without the mineral pigment) was incrementally smoother than paper coated with coating 1.

Table 1 illustrates various coat weights and smoothness calculations. Sample 1 was uncoated base stock. Samples 2-7 had various coat weights and various coating mixtures as indicated. The hollow sphere pigments were approximately 1.0 μm diameter, with a 55% void volume, such as ROPAQUE© HP-1055 from Rohm and Haas Company. The mineral pigment was CaCO₃, either 0.7 micron nominal particle diameter, commercially available as Hydrocarb 90, or 1.8 micron nominal particle diameter, commercially available as Hydrocarb 60 from Omya, Inc. Hydrocarb 90 was used incrementally in coating samples 2, 3, and 4. Hydrocarb 60 was used in coating samples 4, 5, and 7. In each sample the coatings were prepared according to the invention. The roughness of the coated paper after drying was measured by a non-contact laser based instrument.

TABLE 1

| | | Applied | | Hollow | Mineral | | |
|---|---|---|---|---|---|---|---|
| | Basis | Coat | | Plastic | Pigment | | |
| | Weight | Weight | | Spheres | by % of | | UBM |
| | (gram | (grans/ | Total | by Total | Total | Cali- | Rough- |
| Sam- | square | square | Basis | Pigment | Pigment | per | ness |
| ple | meter) | meter) | Weght | Weight | weight | (mils) | (R_{A}) |
| Uncoat- | 167 | 0 | 167 | 0 | 0 | 162 | 1.38 |
| ed | | | | | | | |
| 2 | 167 | 7.5 | 175 | 5% | 75% | 169 | 0.49 |
| 3 | 167 | 9.3 | 176 | 10% | 85% | 168 | 0.61 |
| 4 | 167 | 9.6 | 177 | 15 | 95% | 171 | 0.63 |
| 5 | 167 | 8.6 | 176 | 5% | 75% | 168 | 0.45 |
| 6 | 167 | 9.6 | 177 | 10% | 85% | 173 | 0.63 |
| 7 | 167 | 9.6 | 177 | 15% | 95% | 171 | 0.73 |

The data shows that improvements in surface smoothness can be obtained even with low coat weights and low levels of hollow sphere plastic pigment. These results show that a coated basestock may be manufactured according to the invention to meet desired caliper and basis weight for photographic applications, while at the same time having superior surface smoothness.

The invention includes many other embodiments that may not be herein described in detail, but would nonetheless be appreciated by those skilled in the art from the disclosures made. Accordingly, this disclosure should not be read as being limited only to the foregoing examples or only to the designated preferred embodiments.

26. A method of manufacturing a coated paper comprising:
providing a base stock;
coating said base stock with a size coating;
applying a second coating including a hollow sphere plastic pigment, a whitening pigment and a binder said size coating at a coat weight of from about 2.5 pounds per 3,300 square feet to about 10 pounds per 3,300 square feet; and

27 The method of claim 26 wherein said second coating further comprises hollow sphere plastic pigment.

28. The method of claim 27 wherein said hollow sphere plastic pigment has a void volume of about 22% to about 64%.

29. The method of claim 26 wherein the whitening pigment is selected from the group consisting of calcium carbonate, barium sulfate, titanium oxides, and metal silicates.
